(19) United States
(12) Patent Application Publication
(10) Pub. No.: US 2024/0151307 A1
(43) Pub. Date: May 9, 2024

(54) TORQUE TRANSMISSION UNIT, METHOD FOR PRODUCING THE TORQUE TRANSMISSION UNIT, AND HYBRID TRANSMISSION

(71) Applicant: Schaeffler Technologies AG & Co. KG, Herzogenaurach (DE)

(72) Inventors: Lionel Huber, Drusenheim (FR); Steffen Lehmann, Ettlingen (DE)

(73) Assignee: Schaeffler Technologies AG & Co. KG, Herzogenaurach (DE)

(21) Appl. No.: 18/280,474

(22) PCT Filed: Feb. 25, 2022
(86) PCT No.: PCT/DE2022/100158

§ 371 Date: Sep. 6, 2023

(30) Foreign Application Priority Data
Mar. 31, 2021 (DE) 10 2021 108 129.7

(51) Int. Cl. F16H 63/34; B60K 6/40; F16B 19/06; F16H 57/00

(52) U.S. Cl. CPC F16H 63/3425; B60K 6/40; F16H 57/0025; B60Y 2200/92; F16B 19/06

(57) ABSTRACT

A torque transmission unit is designed to be used in a hybrid transmission of a motor vehicle and includes a shaft configured to mechanically couple to a rotor of a rotary electric machine and a ratchet wheel for a parking lock device configured to block a rotational movement of the torque transmission unit. The rachet wheel includes teeth that, at least in part, have a greater hardness than the shaft. The ratchet wheel is rotationally fixed to the shaft rivets.

### CROSS-REFERENCE TO RELATED APPLICATIONS

This application is the U.S. National Phase of PCT Appln. No. PCT/DE2022/100158 filed Feb. 25, 2022, which claims priority to DE 102021108129.7 filed Mar. 31, 2021, the entire disclosures of which are incorporated by reference herein.

### TECHNICAL FIELD

The present disclosure relates to a torque transmission unit, a method for producing the torque transmission unit and a hybrid transmission having the torque transmission unit.

### BACKGROUND

Parking locking devices for securing the position of a parked vehicle are known. Hand brakes were usually used for this purpose, which exert a mechanical braking effect on the wheels of the motor vehicle to block them when the vehicle is stationary and in this way to secure the parked vehicle in the parking position.

On the other hand, other known parking locking devices act on the drive axle of the vehicle to block the driven wheels. The blocking effect should also occur when a separating clutch between the engine and transmission of the motor vehicle is disengaged and the engine brake is therefore not acting on the vehicle. This means that when the motor vehicle is parked, the braking effect of the engine cannot be used to prevent the vehicle from rolling away unintentionally. Accordingly, it is usually provided that the parking lock device acts on the output side of the transmission and thus on the drive train of the motor vehicle itself to block the rotational movement of the wheels.

Here, a ratchet wheel, which is rotationally fixed to a transmission shaft, is usually arranged. This ratchet wheel has teeth, usually external teeth, into which a pawl of the parking lock device can engage to block the rotational movement of the shaft.

However, insofar as the parking lock device is designed to be open during normal operation, it has the disadvantage that in the event of a failure with interruption of the energy supply to a motor vehicle equipped with the parking lock device, the pawl does not engage in the teeth of the ratchet wheel and consequently does not prevent rotation of the drive train.

This disadvantage is compensated for by parking lock devices that are designed to be closed during normal operation. Above a defined speed, the pawl is rejected by the ratchet wheel; however, there can still be mechanical contact between the pawl and the teeth of the ratchet wheel, which can lead to increased wear. Below this defined speed, the pawl engages in the teeth of the ratchet wheel. However, this is associated with a large number of impulses acting on the teeth, which also has a disadvantageous effect in terms of wear.

Likewise, there is a high mechanical load when the pawl engages in the teeth, especially in the case of rotary impulses exerted by the rotor of a connected rotary electric machine, which are all the stronger the more torsionally rigid the shaft is designed to be, e.g., with a small axial distance between the ratchet wheel and the seat of the rotor on the shaft

In the case of hybrid transmissions in particular, the shaft can also have at least one additional set of teeth to form a transmission stage of a gear meshing with this additional set of teeth. For reasons of space, these additional teeth are often an integral part of the shaft and is therefore made from the shaft material.

FIG. 1 shows a conventional pack locking device 20, with a shaft 10 shown in FIG. 2.

The pack locking device 20 comprises the shaft 10 which can be rotated about a longitudinal axis 11 thereof and a ratchet wheel 21 arranged thereon. Each ratchet wheel 21 has teeth 22 on a radial inner side thereof. The parking lock device 20 also comprises a pawl 23, which can be pivoted by means of a drive unit 24, which can be moved in the movement 25 shown in such a way that it engages in the teeth 22 of the ratchet wheel 21. It can be seen here that when the pawl 23 engages in the teeth 22, depending on the speeds achieved during engagement, high mechanical loads occur which can lead to wear, particularly in the case of a long service life.

FIG. 2 shows a perspective view of the conventionally designed shaft 10 in which the teeth 22 and thus the ratchet wheel 21 are integral parts of the shaft body. It can also be seen here that an external shaft toothing 12 is arranged to be axial directly next to the teeth 22 of the ratchet wheel 21 and can form a transmission stage together with a further gear wheel (not shown here).

Furthermore, the illustrated shaft 10 comprises a rotor seat 16 for accommodating a rotor of a rotary electric machine and, on the end axially opposite the ratchet wheel 21, splines 15 for accommodating clutch components of a clutch which interacts with the shaft 10. In this embodiment of a conventional shaft 10, the external shaft toothing 12 as well as the teeth 22 of the ratchet wheel 21 are made of the same material. This makes it necessary either to design the shaft 10 as a whole from a very hard material to achieve the necessary wear resistance of the teeth 22 of the ratchet wheel 21, or to dispense with a higher hardness and consequently wear resistance of the teeth 22 of the ratchet wheel 21 to be able to produce shaft 10 efficiently overall.

This often leads to a discrepancy in meeting the objectives of efficient production of all the teeth formed by the shaft and the desired degree of hardness for the purpose of reducing wear, since teeth with high hardness can only be produced with correspondingly high manufacturing costs.

### SUMMARY

The present disclosure provides a torque transmission unit, a method for producing the torque transmission unit and a hybrid transmission having the torque transmission unit, which allow the activation of a parking lock device having a long service life in an efficient, space-saving and cost-effective manner.

The features of the claims can be combined in any technically useful manner, wherein the explanations from the following description as well as features from the figures can also be consulted for this purpose, which comprise supplementary embodiments of the present disclosure.

The present disclosure, according to an exemplary embodiment thereof, relates to a torque transmission unit for a hybrid transmission of a motor vehicle, comprising a shaft for mechanically coupling to a rotor of a rotary electric machine and a ratchet wheel for a parking lock device for blocking a rotational movement of the torque transmission unit, wherein the ratchet wheel comprises teeth and the teeth have a higher hardness than the shaft, at least in regions. The ratchet wheel is rotationally fixed to the shaft by means of rivets.

The external teeth are designed to engage a pawl of a parking lock device, so that a rotational movement in a drive train of a motor vehicle can be blocked as a result.

In particular, the teeth are an external toothing, in embodiments having radially extending teeth. Due to the hardness of these teeth, a long service life of the teeth is guaranteed.

In embodiments of the torque transmission unit, the riveting can also be used to fix the two components, the ratchet wheel and the shaft, to one another axially.

The body of the shaft can also form an external shaft toothing that has a lower hardness than the ratchet wheel, at least in some areas. The external shaft toothing is formed from the material of the shaft body and is therefore an integral part of the shaft, so that the shaft body and the shaft toothing form a homogeneous component.

The advantage here is that the external shaft toothing can be produced efficiently using a suitable manufacturing process due to the lower hardness, although the riveting according to the present disclosure means that the assembly made up of shaft and ratchet wheel has a very high hardness in some areas, namely in the teeth of the ratchet wheel.

The ratchet wheel is manufactured as a single part and can be manufactured in a separate hardening process that is adapted to the material and the requirements of the ratchet wheel, regardless of the shaft.

Due to the compressive stress that occurs during riveting and/or during operation of the torque transmission unit on the face of the hole on a respective rivet and the resulting increase in strength of the pre-deformed material, a very robust connection between the ratchet wheel and the shaft is made possible, in particular when the parking lock device is closed in the normal state.

In embodiments, it is provided that the rivets essentially run axially parallel to the longitudinal axis of the shaft, wherein the rivets are arranged, at least in regions, in a shoulder of the shaft and, at least in regions, in the ratchet wheel.

The shoulder of the shaft extends radially so that it forms an axial contact surface against which the ratchet wheel rests axially.

In embodiments, it is provided that at least one of the rivets has a closing head produced by forming after the rivet has been positioned in the shaft and in the ratchet wheel.

In this embodiment, the closing head has thus been realized subsequently after the positioning of the rivet.

A rivet head of the rivet in question can be a button head, or a pan head or a countersunk head. The rivet is inserted into the shoulder of the shaft and into the ratchet wheel in such a way that the rivet head rests on one side on one of the two components of the ratchet wheel and shaft, for example on the shaft shoulder. The opposite end section protrudes from the respective other component and is then formed into a closing head by pressure and/or impact forming.

It makes sense to use a solid rivet for this embodiment of the riveting.

In contrast, another embodiment of the riveting provides that at least one of the rivets is a rivet introduced by means of clinching.

Accordingly, this rivet can also be referred to as a clinch rivet. In contrast to conventional clinching, in which a punch connects two parts to be joined by deforming the two parts and forming an undercut, however, it is provided here that a blind hole having a radial widening formed on the side of the hole base already exists in one of the two components, the ratchet wheel and the shaft. By driving the rivet into this blind hole and compressing the rivet at the bottom of the hole, the rivet enlarges radially so that it forms an undercut in the radial expansion itself. As a result, the translatory degree of freedom along the longitudinal axis thereof is blocked for the rivet. The rivet also has a closing head at the axially opposite end, for example, with which it rests against the other component of the ratchet wheel and shaft, so that the two components of the ratchet wheel and shaft are fixed to one another along the longitudinal direction of the rivet.

Another embodiment of the riveting provides that at least one of the rivets is a threaded rivet having an external thread, the external thread of which forms a threaded connection with an internal thread in one of the two components, ratchet wheel and shaft, and has a closing head produced by forming which rests against the respective other component.

During the manufacture of this rivet connection, the end section of the rivet opposite the external thread protrudes from the respective other component and is formed into a closing head by pressure and/or impact forming.

In embodiments, it is provided here that the threaded rivet has a shaped element arranged on the face side in the body of the threaded rivet for introducing a torque.

This shaped element can in particular be a hexagon socket or a hexalobular socket. In embodiments, it is provided that this shaped element is arranged in the end section axially opposite the external thread.

This shaped element allows the threaded rivet to be screwed into the internal thread by applying a torque via the shaped element. When the threaded rivet has reached the desired position thereof in the axial direction, it is deformed in the end section having the shaped element by pressure and/or impact deformation, so that it forms a closing head.

In the case of the shaft as one of the two components to be connected by means of riveting, it is provided, in embodiments, that a respective riveting covered by the present disclosure is carried out in or through a shoulder of the shaft formed integrally with the shaft.

The riveted connections, in particular the threaded rivets, are particularly suitable where space is limited on the shaft, since the production of the riveted connections requires relatively little space during assembly.

A further aspect of the present disclosure is a method for producing a torque transmission unit according to the present disclosure, in which are provided a shaft for mechanically coupling to a rotor of a rotary electric machine and a ratchet wheel for a parking lock device for blocking a rotational movement of the torque transmission unit, wherein the ratchet wheel comprises teeth and the teeth have a greater hardness than the shaft, at least in regions, and the ratchet wheel is connected to the shaft in a rotationally fixed manner by means of rivets.

This method can be implemented in such a way that at least one of the rivets is positioned in the shaft and in the ratchet wheel so that it penetrates these two components, and a rivet head of this rivet rests against one of the two components, shaft and ratchet wheel, and then a closing head of the rivet is formed by forming in the end section opposite this rivet head. As a result, the two components, the shaft and the ratchet wheel, are fixed to one another in the axial direction by the two heads formed by the rivet.

An alternative method provides that in one of the two components, ratchet wheel and shaft, a blind hole is formed with a radial widening on the side of the hole base, and a rivet is driven into this blind hole so that it is compressed at the hole base and enlarged radially, so that it itself forms an undercut in the radial expansion.

As a result, the translatory degree of freedom along the longitudinal axis thereof is blocked for the rivet. The rivet also has a closing head at the axially opposite end, for example, with which it rests against the other component of the ratchet wheel and shaft, so that the two components of the ratchet wheel and shaft are fixed to one another along the longitudinal direction of the rivet.

Furthermore, the method can alternatively be carried out in such a way that at least one of the rivets is a threaded rivet with an external thread, which is screwed into an internal thread in one of the two components, the ratchet wheel and the shaft, and a closing head of the threaded rivet is produced by forming and rests against the respective other component.

Thus, the end section of the rivet opposite the external thread protrudes from the respective other component after the screwing-in process, and is then formed into a closing head by pressure and/or impact forming.

Insofar as the threaded rivet has a shaped element arranged on the face side in the body of the threaded rivet for applying a torque, it is provided that this shaped element or the material forming this shaped element is also shaped by the pressure and/or impact deformation, so that this shaped element is at least partially destroyed when the closing head is formed.

In addition, the present disclosure provides a hybrid transmission that comprises a torque transmission unit according to the present disclosure and at least one rotary electric machine, the rotor of which is coupled in a rotationally fixed manner to the shaft of the torque transmission unit, and also comprises a parking lock device for engaging in the teeth of the ratchet wheel of the torque transmission unit.

In particular, this hybrid transmission can be designed in such a way that the axial distance between the rotor and the ratchet wheel is relatively small, in particular not greater than the diameter of the shaft of the torque transmission unit.

Correspondingly, the shaft of the torque transmission unit between the ratchet wheel and rotor is very short and therefore very torsionally rigid; however, any angular momentum transmitted from the rotor to the shaft can still be absorbed by the ratchet wheel due to the great hardness of the teeth.

In embodiments of the hybrid transmission, it is provided that the ratchet wheel has the additional function of axially securing a needle bearing for supporting the shaft.

With this hybrid transmission, a hybrid drive arrangement can thus also be made available which has a hybrid transmission according to the present disclosiure and an internal combustion engine the output of which is mechanically coupled to a connecting device of the hybrid transmission.

### BRIEF DESCRIPTION OF THE DRAWINGS

The present disclosure described above is explained in detail below in light of the pertinent technical background with reference to the accompanying drawings, which show exemplary embodiments. The present disclosure is not limited in any way by the purely schematic drawings, wherein it should be noted that the embodiments shown in the drawings are not limited to the dimensions shown. In the drawings:

FIG. 1: shows a parking lock device according to the prior art,

FIG. 2: shows a shaft having a ratchet wheel according to the prior art,

FIG. 3: shows a separate ratchet wheel according to the present disclosure,

FIG. 4: shows a solid rivet in a perspective view,

FIG. 5: shows a detail from a torque transmission unit according to the present disclosure of a first embodiment,

FIG. 6: shows a partial view of a second embodiment of a hybrid module according to the present disclosure,

FIG. 7: shows a section of a torque transmission unit according to the present disclosure of a third embodiment,

FIG. 8: shows a front view of a shaft having a ratchet wheel arranged according to the present disclosure,

FIG. 9: shows a threaded rivet in a view from the side, and

FIG. 10: shows the threaded rivet from FIG. 9 in a front view.

### DETAILED DESCRIPTION

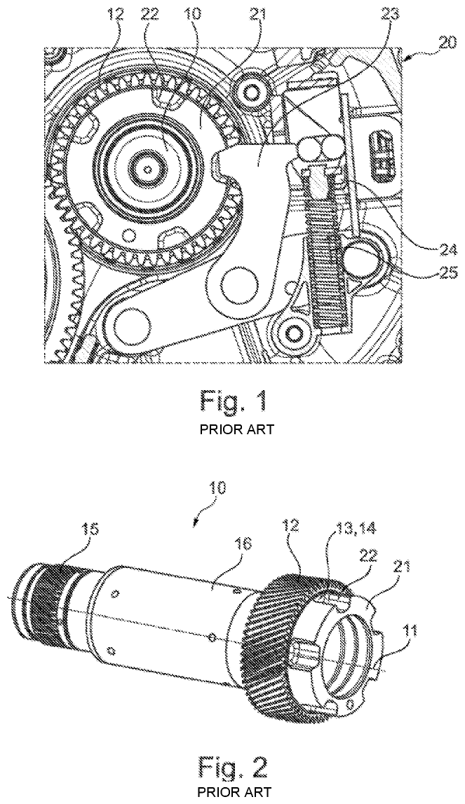

FIGS. 1 and 2 have already been discussed for the purpose of explaining the prior art.

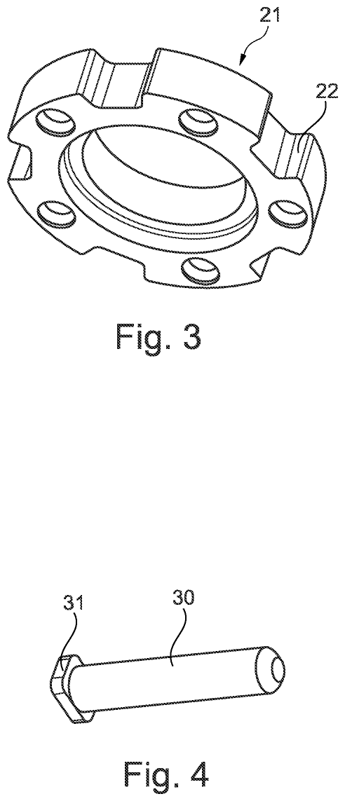

FIG. 3 shows a ratchet wheel 21 which, according to the basic idea of the present disclosure, is to be designed as a separate and hard component, at least in the area of the teeth 22 thereof.

It can be seen that the ratchet wheel 21 already has pre-drilled holes for accommodating rivets.

FIG. 4 first shows a rivet 30 to be used according to the present disclosure for fixing the ratchet wheel 21. This rivet 30 is designed as a solid rivet and comprises a rivet head 31.

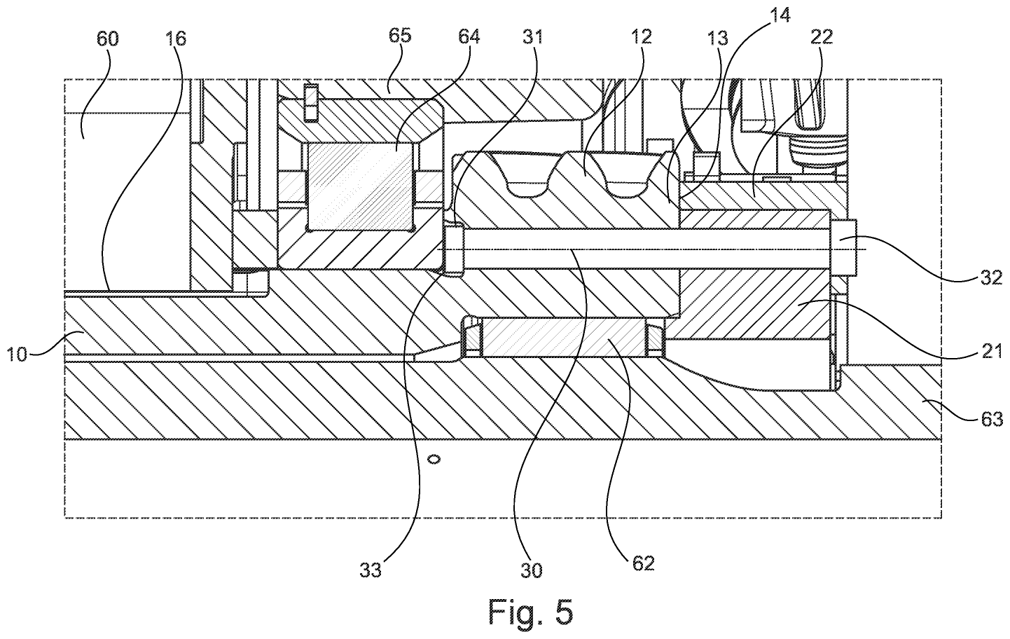

FIGS. 5-7 show different ways of fastening this ratchet wheel 21 to a shaft 10 using the sections shown from a hybrid transmission according to the present disclosure, in which essential aspects of the torque transmission unit according to the present disclosure can be seen.

FIG. 5 shows the use of this rivet 30 to attach the ratchet wheel 21. Here the rivet 30 has been pushed through a hole in a shoulder 13 of the shaft 10 and through the ratchet wheel 21 so that the rivet head 31 sits in a relief groove 33 present in the shoulder 13. As a result, the rivet 30 protrudes axially from the ratchet wheel 21. At this point, a closing head 32 has been produced by reshaping the rivet 30. As a result, the ratchet wheel 21 is fixed in an axial direction and also in a circumferential direction on the shoulder 13 of the shaft 10. The ratchet wheel 21 rests against an axial contact surface 14 of the shoulder 13. The shoulder 13 forms the external shaft toothing 12 on the radial outside thereof.

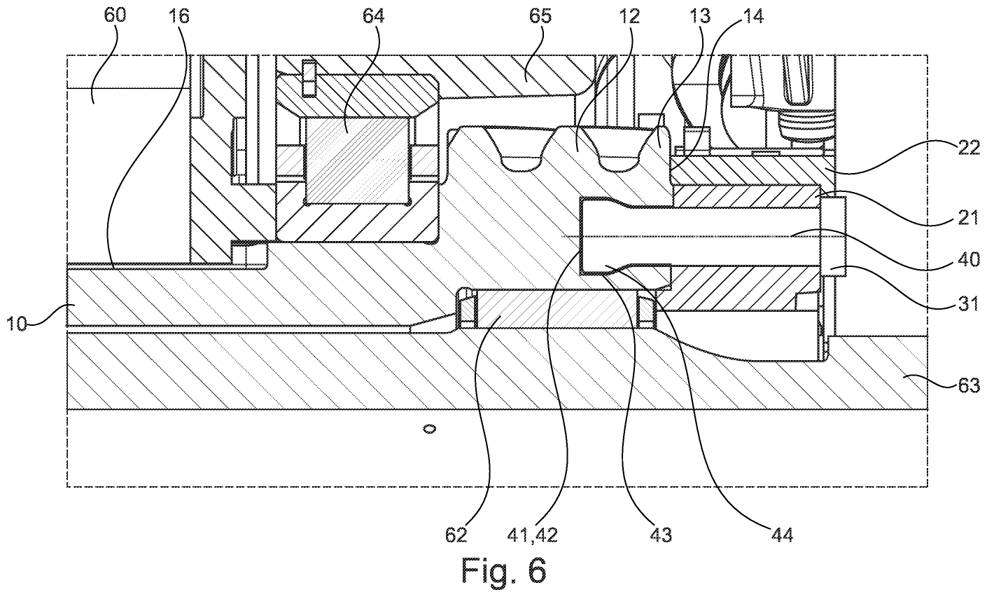

FIG. 6 shows an alternative embodiment of the torque transmission unit according to the present disclosure. A rivet in the form of a clinch rivet 40 has been used here. This clinch rivet 40 has been placed in a blind hole 41 in the shoulder 13 of the shaft 10. This blind hole 41 has a radial expansion 43 at the hole base 42 thereof. By driving the clinch rivet 40 from the side of the ratchet wheel 21, this clinch rivet 40 is compressed on the hole base 42 so that it is deformed into the radial expansion 43 or flows into the radial expansion 43. In this way, the clinch rivet 40 forms an undercut 44 in the radial expansion 43, which blocks degree of axial freedom of the clinch rivet 40 along a longitudinal axis thereof. At the end axially opposite the undercut 44, the clinch rivet 40 comprises a rivet head 31 with which it bears against the ratchet wheel 21. In this way, the ratchet wheel 21 is fixed to the shoulder 13 of the shaft 10.

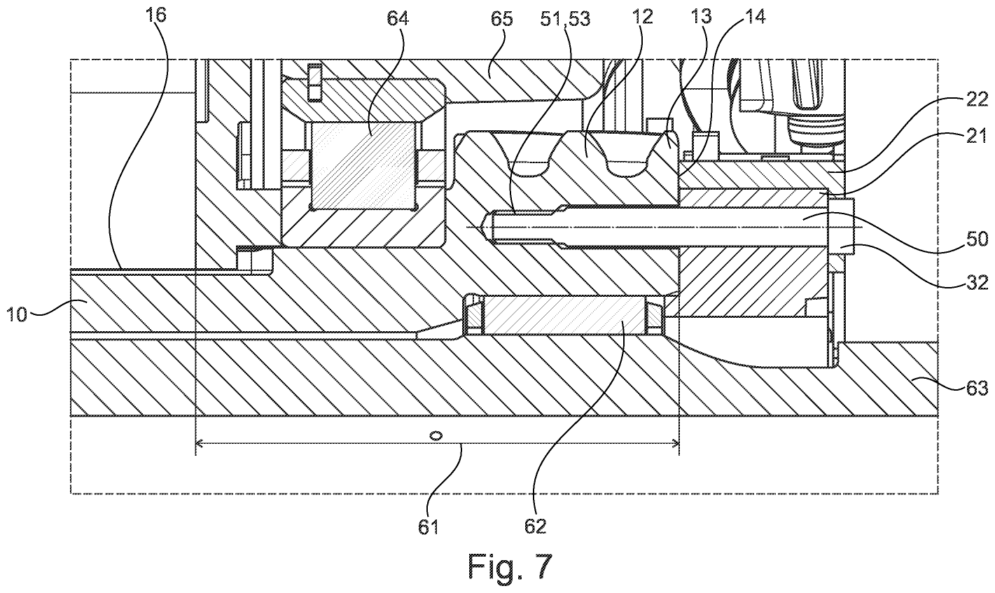

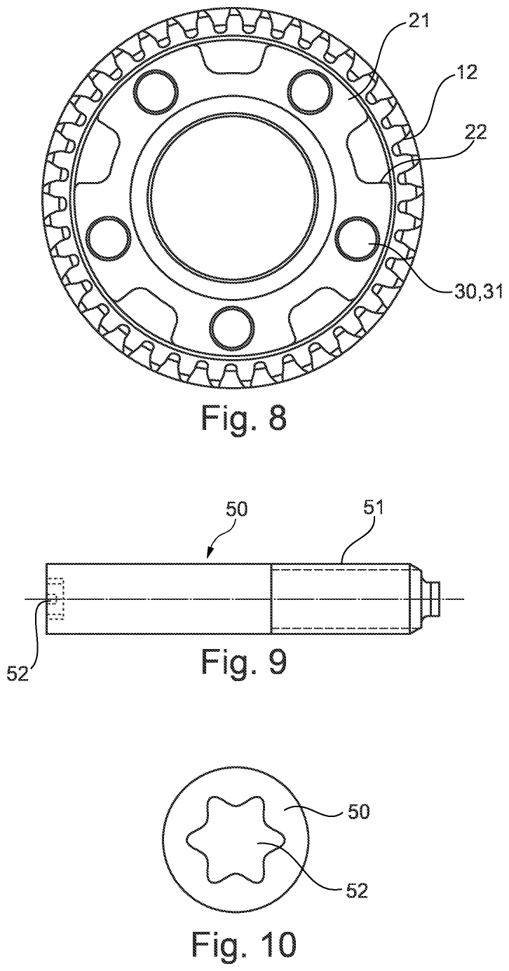

FIG. 7 shows a further alternative embodiment of a torque transmission unit according to the present disclosure.

The rivet used here is a threaded rivet 50. This threaded rivet 50 is screwed through a hole in the ratchet wheel 21 into an internal thread 53 in the shoulder 13 of the shaft 10 so that an external thread 51 of the threaded rivet 50 together with the internal thread 53 forms a threaded connection.

For this purpose, in an exemplary embodiment, the threaded rivet 50 comprises a shaped element 52 for applying a torque to the threaded rivet 50 on the front end thereof facing away from the external thread 51, as can be seen in particular in FIGS. 9 and 10. In the embodiment shown here, this shaped element 52 is a hexalobular socket.

After the insertion of this threaded rivet 50 into the ratchet wheel 21 and also into the shoulder 13 of the shaft 10, a closing head 32 is produced on the side of the ratchet wheel 21 by reshaping, in particular by impact impulses, so that also in this embodiment the ratchet wheel 21 is fixed at shoulder 13 of the shaft 10.

As shown by way of example in FIG. 7, an axial distance 61 of the ratchet wheel 21 to a rotor 60 is relatively small, so that the section of the shaft 10 located in between is torsionally rigid, so that rotary impulses acting on the shaft 10 are passed along essentially undamped. Due to the relatively high hardness of the teeth 22 of the ratchet wheel 21, however, rotational impulses applied to the teeth cause little or no wear.

It goes without saying that the rivets shown in FIGS. 5-7 are arranged in plurality on a partial circumference of the ratchet wheel.

It can also be seen from FIGS. 5-7 that the ratchet wheel 21 fixed on the shoulder 13 of the shaft 10 forms an axial stop for a needle bearing 62 which is seated on a second shaft 63 and which supports the shaft 10 on the second shaft 63.

In addition, a roller bearing 64 can be seen in each of FIGS. 5-7 for supporting and mounting the shaft 10 in a housing 65. Furthermore, the rotor 60 of a rotary electric machine arranged on the rotor seat 16 can also be seen in part.

The proposed torque transmission unit provides a device which combines a long service life of the teeth on the ratchet wheel of the parking lock device with an efficient manufacturing process.

### LIST OF REFERENCE SYMBOLS

10 Shaft
11 Longitudinal axis
12 External shaft toothing
13 Shoulder
14 Axial contact surface
15 Splines
16 Rotor seat
20 Parking lock device
21 Ratchet wheel
22 Teeth
23 Pawl
24 Drive unit
25 Movement
30 Rivet
31 Rivet head
32 Closing head
33 Relief groove
40 Clinch rivet
41 Blind hole
42 Hole base
43 Radial expansion
44 Undercut
50 Threaded rivet
51 External thread
52 Shaped element
53 Internal thread
60 Rotor
61 Axial distance
62 Needle bearing
63 Second shaft
64 Rolling bearing
65 Housing

1. A torque transmission unit for a hybrid transmission of a motor vehicle, comprising:
a shaft configured to mechanically couple to a rotor of a rotary electric machine; and
a ratchet wheel for a parking lock device configured to block a rotational movement of the torque transmission unit, wherein the ratchet wheel includes teeth and the teeth have a greater hardness than the shaft, at least in regions;
wherein the ratchet wheel is rotationally fixed to the shaft via rivets.

2. The torque transmission unit according to claim 1, wherein the rivets extend axially parallel to a longitudinal axis of the shaft, wherein the rivets are arranged, at least in regions, in a shoulder of the shaft and, at least in regions, in the ratchet wheel.

3. The torque transmission unit according to claim 1, wherein at least one of the rivets, after positioning of the rivet in the shaft and in the ratchet wheel has a closing head generated by forming.

4. The torque transmission unit according to claim 1, wherein at least one of the rivets is introduced via clinching.

5. The torque transmission unit according to claim 1, wherein at least one of the rivets is a threaded rivet having an external thread, the external thread of which forms a threaded connection with an internal thread in one of the ratchet wheel and shaft and has a closing head produced by forming and arranged to rests against the other of the ratchet wheel and the shaft.

6. A method for producing a torque transmission unit, comprising:
providing a shaft configured to mechanically couple a rotor of a rotary electric machine;
providing a ratchet wheel (21) for a parking lock device (20) configured to block a rotational movement of the torque transmission unit, wherein the ratchet wheel comprises teeth and the teeth have a greater hardness than the shaft, at least in regions, and
rotationally fixing the ratchet wheel to the shaft via rivets.

7. The method of producing a torque transmission unit according to claim 6, further comprising positioning at least one of the rivets in the shaft and in the ratchet wheel so that the at least one rivet penetrates the shaft and the rachet wheel, wherein a rivet head of the at least one rivet rests on one of the shaft and the ratchet wheel, and a closing head of the at least one rivet is formed by forming an end section opposite the rivet head.

8. The method for producing a torque transmission unit according to claim 6, further comprising forming a blind hole having a radial expansion formed on a side of a hole base (42) in one of the the ratchet wheel and the shaft, and driving one of the rivets into the blind hole so that the rivet is compressed at the hole base and enlarged radially thereby forming an undercut in the radial expansion.

9. The method for producing a torque transmission unit according to claim 6, wherein at least one of the rivets is a threaded rivet having an external thread, which is screwed into an internal thread in one of the ratchet wheel and the shaft, and a closing head of the threaded rivet is produced by forming and rests against the other of the rachet wheel and the shaft.

10. A hybrid transmission, comprising,
a rotary electric machine having rotor;
a torque transmission unit having a shaft coupled in a rotationally fixed manner to the rotor and a ratchet wheel, the ratchet wheel including teeth and being configured to block a rotational movement of the torque transmission unit; and
a parking lock device engaged with the teeth in the ratchet wheel;
wherein the teeth have a greater hardness than the shaft, at least in regions;
wherein the ratchet wheel is rotationally fixed to the shaft via a rivet.

11. The hybrid transmission according to claim 10, wherein the rivet extends axially parallel to a longitudinal axis of the shaft, wherein the rivet is arranged, at least in regions, in a shoulder of the shaft and, at least in regions, in the ratchet wheel.

12. The hybrid transmission according to claim 10, wherein the rivet, after positioning of the rivet in the shaft and in the ratchet wheel, has a closing head generated by forming.

13. The hybrid transmission according to claim 10, wherein the rivet is introduced via clinching.

14. The hybrid transmission according to claim 10, wherein the rivets is a threaded rivet having an external thread, the external thread of which forms a threaded connection with an internal thread in one of the ratchet wheel and shaft and has a closing head produced by forming and arranged to rest against the other of the ratchet wheel and the shaft.

15. The torque transmission unit according to claim 2, wherein the shoulder is formed integrally with the shaft.

16. The hybrid transmission according to claim 11, wherein the shoulder is formed integrally with the shaft.

17. The method according to claim 7, wherein the at least one rivet extends through a shoulder of the shaft formed integrally with the shaft.

18. The torque transmission unit according to claim 5, wherein the threaded rivet includes a shaped element configured to receive a torque, the shaped element being arranged axially opposite the external thread.

19. The hybrid transmission according to claim 14, wherein the threaded rivet includes a shaped element configured to receive a torque, the shaped element being arranged axially opposite the external thread.

20. The method according to claim 9, wherein the threaded rivet includes a shaped element configured to receive a torque, the shaped element being arranged axially opposite the external thread.
